(19) United States
(12) Patent Application Publication
(10) Pub. No.: US 2019/0035032 A1
(43) Pub. Date: Jan. 31, 2019

(54) SYSTEM AND METHOD FOR DETECTING AND RESPONDING TO TRANSACTION PATTERNS

(71) Applicant: Clarity Money, Inc., New York, NY (US)

(72) Inventors: Hossein Azari Soufiani, New York, NY (US); Adam Dell, New York, NY (US); Matt Jacobs, New York, NY (US); Vishal Srivastava, Wood-Ridge, NJ (US)

(21) Appl. No.: 15/659,081

(22) Filed: Jul. 25, 2017

(51) Int. Cl. G06Q 40/00; G06F 17/30; G06F 17/14

(52) U.S. Cl. CPC G06Q 40/12; G06F 17/14; G06F 17/30604

(57) ABSTRACT

A system and method for detecting and responding to transaction patterns includes one or more servers having one or more processors, one or more databases communicably coupled to the one or more servers, and one or more remote devices communicably coupled to the one or more servers. The processor(s) cause the server(s) to: (a) identify one or more time-based patterns in a set of transaction data stored in the one or more databases corresponding to a data pair over a time period using a spectral decomposition of the set of transaction data, (b) classify the identified time-based pattern(s) into at least two pattern categories comprising a recurring transaction and a non-recurring transaction, (c) generate one or more actions for each pattern category, and (d) respond to the identified time-based pattern(s) by causing the one or more remote devices to perform the one or more actions.

### CROSS-REFERENCE TO RELATED APPLICATIONS

None.

### STATEMENT OF FEDERALLY FUNDED RESEARCH

None.

### TECHNICAL FIELD OF THE INVENTION

The present invention relates in general to the field of financial analysis, and more particularly, to a system and method for detecting and responding to transaction patterns.

### BACKGROUND OF THE INVENTION

Without limiting the scope of the invention, its background is described in connection with financial analysis.

Prior art financial analysis systems and methods often analyze a user's spending and provide recommendations based on third-party offers or a comparison to other users. The recommendations may relate to budgeting or spending categories. Other systems and methods analyze the user's spending to provide targeted offers and/or advertising. However, these systems and methods do not identify patterns on recurring and sporadic non-recurring spending from transaction data and provide actions based on those patterns.

### SUMMARY OF THE INVENTION

The present invention uses principled data science techniques to identify time-based patterns in transaction data. These time-based patterns may include recurring transactions and non-recurring transactions. Spectral decomposition of the transaction data is one possible detection technique. Actions based on these time-based patterns are generated and performed.

In one embodiment of the present invention, a system for detecting and responding to transaction patterns includes one or more servers having one or more processors, one or more databases communicably coupled to the one or more servers, and one or more remote devices communicably coupled to the one or more servers. The one or more processors cause the one or more servers to: (a) identify one or more time-based patterns in a set of transaction data stored in the one or more databases corresponding to a data pair over a time period using a spectral decomposition of the set of transaction data, (b) classify the identified time-based pattern(s) into at least two pattern categories comprising a recurring transaction and a non-recurring transaction, (c) generate one or more actions for each pattern category, and (d) respond to the identified time-based pattern(s) by causing the one or more remote devices to perform the one or more actions.

In another embodiment of the present invention, a computerized method for detecting and responding to transaction patterns includes providing one or more processors communicably coupled to a communications interface and one or more databases. One or more time-based patterns are identified in a set of transaction data stored in the one or more databases corresponding to a data pair over a time period using a spectral decomposition of the set of transaction data by the one or more processors. The identified time-based pattern(s) are classified into at least two pattern categories comprising a recurring transaction and a non-recurring transaction using the one or more processors. One or more actions are generated for each pattern category using the one or more processors. The identified time-based pattern(s) are responded to by causing one or more remote devices communicably coupled to the one or more processors to perform the one or more actions via the communications interface.

In yet another embodiment of the present invention, a computerized method for detecting and responding to transaction patterns includes providing one or more processors communicably coupled to a communications interface and one or more databases. A set of transaction data is received, wherein each transaction data includes at least a user identifier, a recipient identifier, a date and an amount. A data array of transactions corresponding to a data pair over a time period is created from the set of transaction data. The data array of transactions is stored in a first array data structure in the one or more databases. One or more time-based patterns are identified in the set of transaction data stored in the one or more databases corresponding to the data pair over the time period by projecting the set of transaction data into a frequency domain using a Fourier transformation and identifying any dominant frequencies within the frequency domain using the one or more processors. The identified time-based pattern(s) are classified into at least two pattern categories including a recurring transaction and a non-recurring transaction using the one or more processors, wherein any data pairs corresponding to the identified dominant frequencies, if any, are classified as the recurring transaction and any data pairs that do not correspond to the identified dominant frequencies are classified as the non-recurring transaction. One or more actions are generated for each pattern category using the one or more processors. The identified time-based pattern(s) are responded to by causing one or more remote devices communicably coupled to the one or more processors to perform the one or more actions via the communications interface.

In yet another embodiment of the present invention, a system for detecting and responding to transaction patterns includes one or more servers having one or more processors, one or more databases communicably coupled to the one or more servers, and one or more remote devices communicably coupled to the one or more servers. The one or more processors cause the one or more servers to: (a) receive a set of transaction data, each transaction data comprising at least a user identifier, a recipient identifier, a date and an amount; (b) create a data array of transactions corresponding to a data pair over a time period from the set of transaction data; (c) store the data array of transactions in a first array data structure in the one or more databases; (d) identify one or more time-based patterns in the set of transaction data stored in the one or more databases corresponding to the data pair over the time period by projecting the set of transaction data into a frequency domain using a Fourier transformation and identifying any dominant frequencies within the frequency domain using the one or more processors; (e) classify the identified time-based pattern(s) into at least two pattern categories comprising a recurring transaction and a non-recurring transaction using the one or more processors, wherein any data pairs corresponding to the identified dominant frequencies, if any, are classified as the recurring transaction and any data pairs that do not correspond to the identified dominant frequencies are classified as the non-recurring transaction; (f) generate one or more actions for each pattern category; and (g) respond to the identified time-based pattern(s) by causing the one or more remote devices to perform the one or more actions.

In addition, the present invention can be implemented as a non-transitory computer readable medium containing program instructions that cause one or more processors to perform a method for detecting and responding to transaction patterns as described above in reference to the computerized method.

In addition to the foregoing, various other method, system, and apparatus aspects are set forth in the teachings of the present disclosure, such as the claims, text, and drawings forming a part of the present disclosure.

The foregoing is a summary and thus contains, by necessity, simplifications, generalizations, and omissions of detail. Consequently, those skilled in the art will appreciate that this summary is illustrative only and is not intended to be in any way limiting. There aspects, features, and advantages of the devices, processes, and other subject matter described herein will become apparent in the teachings set forth herein.

### BRIEF DESCRIPTION OF THE DRAWINGS

For a more complete understanding of the features and advantages of the present invention, reference is now made to the detailed description of the invention along with the accompanying figures, in which:

FIG. 1 shows a block diagram of a system in accordance with an embodiment of the present invention;

FIG. 2 shows a flow chart of a computerized method in accordance with an embodiment of the present invention;

FIG. 3 shows a flow chart of a computerized method in accordance with another embodiment of the present invention;

FIG. 4 shows an example of array data for transactions between a merchant and a user over time;

FIG. 5 shows an example of a frequency domain representation of user and merchant transaction data;

FIGS. 6A-6B show an example of two categories of spending patterns: a monthly recurring pattern (FIG. 6A), and a mixed frequency pattern with no dominant frequency, representing a non-recurring pattern (FIG. 6B);

FIGS. 7A-7B show an example of two recommendations based on spectral filtering of spending patterns: filtering a specific recurring frequency through cancellation of the recurring charge (FIG. 7A), and removing the higher frequency spendings (FIG. 7B);

FIGS. 8A-8B show examples of suggestions and recommendations for specific transactions: suggestions to reduce specific sporadic but non-recurring transactions (FIG. 8A), and requesting cancellation of specific recurring charges (FIG. 8B);

FIG. 9 shows a flow chart of an exemplary implementation of the present invention;

FIG. 10 shows a flow chart of a pattern determination method in accordance with another embodiment of the present invention; and

FIG. 11 shows a flow chart of a computerized method in accordance with another embodiment of the present invention.

### DETAILED DESCRIPTION OF THE INVENTION

Illustrative embodiments of the system of the present application are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

The present invention uses principled data science techniques to identify time-based patterns in transaction data. These time-based patterns may include recurring transactions and non-recurring transactions. Spectral decomposition of the transaction data is one possible detection technique. Actions based on these time-based patterns are generated and performed.

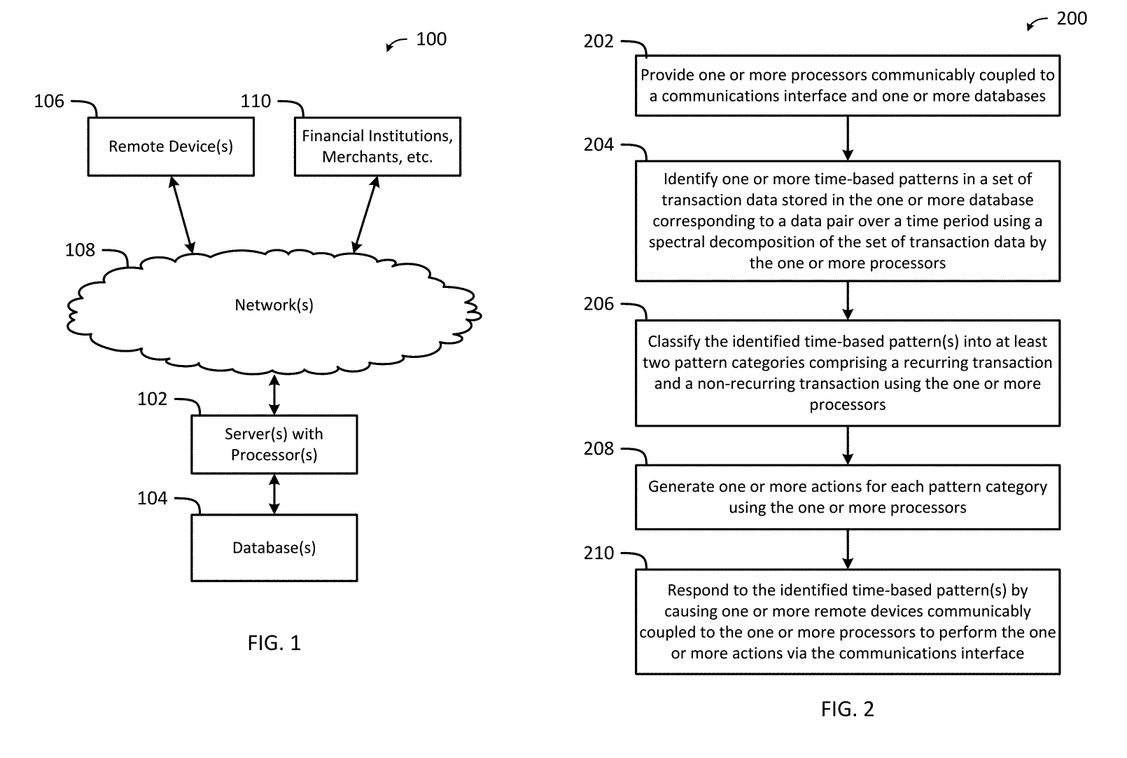

Now referring to FIG. 1, a block diagram of a system 100 in accordance with an embodiment of the present invention is shown. The system 100 for detecting and responding to transaction patterns includes one or more servers 102 having one or more processors, one or more databases 104 communicably coupled to the one or more servers 102, and one or more remote devices 106 communicably coupled to the one or more servers 102 via one or more networks 108 or communication interfaces. The one or more processors cause the one or more servers to: (a) identify one or more time-based patterns in a set of transaction data stored in the one or more databases corresponding to a data pair over a time period using a spectral decomposition of the set of transaction data, (b) classify the identified time-based pattern(s) into at least two pattern categories comprising a recurring transaction and a non-recurring transaction, (c) generate one or more actions for each pattern category, and (d) respond to the identified time-based pattern(s) by causing the one or more remote devices to perform the one or more actions. The system 100 may also include communications with other devices and systems 110, such as financial institutions, merchants, services, etc.

All the devices within the system 100 can communicate with one another over various networks 108, such as public networks, private networks, local networks, wide area networks, wired connections, wireless connections, or any other form of known or unknown communication mechanism using known or unknown protocols. As will be appreciated by those of ordinary skill in the art, the system 100 can include other devices, components, modules, etc., and is not limited to the specific embodiments described herein in connection with the figures. Moreover, the server(s) 102 can be any type of processing or computing device using any combination of hardware and software suitable for performing the processes described herein. As will be appreciated by those of ordinary skill the art, the server(s) 102 can be multiple computers, multiple processors and may include many other components, devices and/or peripherals. Moreover, the server(s) 102 and the processes described herein can be implemented in a distributed architecture at multiple geographic locations. Likewise, processing can be shared or distributed between the server(s) 102 and the remote device(s) 106.

The remote device(s) 106 can include a server, computer, laptop computer, hand-held computing device, mobile communications device, electronic token, electronic wearable device (e.g., wrist watch, bracelet, glasses, etc.), transaction processing device (e.g., point-of-sale device, kiosk, cash register, credit/debit card machine, etc.) or a payment processing system. Note that other devices can be used. The transaction can be a purchase, a sale, a lease, an order, a payment, a deposit, a transfer, a receipt or a barter exchange. Note that other types of transactions can be used. Moreover, the transaction can be a pending or proposed transaction awaiting approval or authorization. The one or more actions can include displaying a recommended course of action on the remote device(s) 106, displaying an alert or warning on the remote device(s) 106, displaying a prompt on the remote device(s) 106 to cancel or allow a pending transaction, the recurring transaction or the non-recurring transaction, or blocking the pending transaction, the recurring transaction or the non-recurring transaction until an override message is received from the remote device(s) 106. Note that other types of actions can be used. Moreover, the one or more actions can execute other application(s) or software program(s) resident on the remote device(s) 106 or cause the remote device(s) 106 to communicate or interact with other devices with or without user interaction.

The one or more processors can cause the one or more servers to further perform one or more of the following:

select the data pair from at least one user identifier and at least one recipient identifier stored in a data structure in the one or more databases; or

select the data pair from the at least one user identifier and at least one transaction category stored in the data structure in the one or more databases; or

receive the transaction data comprising at least a user identifier, a recipient identifier, a date and an amount, and store the transaction data in a data structure in the one or more databases; or

request the transaction data from one or more third party devices; or

assign a transaction category to the transaction data; or

create a data array of transactions corresponding to the data pair over the time period, wherein the set of transaction data comprises the data array of transactions, and store the data array of transactions in a first array data structure in the one or more databases; or

store the spectral decomposition of the set of transaction data in a second array data structure in the one or more databases; or

generate the one or more actions by selecting the one or more actions from a mapping of each pattern category to a set of actions in a pattern to action table stored in the one or more databases; or

store the one or more actions in a user action table in the one or more databases; or

respond to the identified time-based pattern(s) by further querying the one or more actions in the user action table; or

receive a new transaction data corresponding to a new completed transaction, a new pending transaction or a new predicted transaction, and store the new transaction data in the data structure; or

add the new transaction data to the set of transaction data, and repeat the analyzing, classifying, generating and responding steps; or

generate one or more new actions whenever the new transaction data matches one or more of the pattern categories, or invokes one or more of the stored actions, and cause the one or more remote devices communicably coupled to the one or more processors to perform the one or more new actions via the communications interface; or

determine whether the recommended course of action was performed, send a congratulatory message to the one or more remote devices whenever the recommended course of action was performed, and send an alert message to the one or more remote devices whenever the recommended course of action was not performed; or

receive a cancellation message, which may include an authorization code, from the one or more remote devices in response to the prompt, and send a cancellation request to a third-party device for the pending transaction, the recurring transaction or the non-recurring transaction; or

receive an allow message from the one or more remote devices in response to the prompt, and send an authorization message to a third-party device for the pending transaction; or

execute one or more applications on the one or more remote devices in response to the one or more actions; or

determine a geographic location of a user, and predict a destination location based on the geographic location of the user and one of the recurring transactions or one of the non-recurring transactions associated with the user, wherein the one or more actions are based on the destination location.

The user identifier can correspond to an individual, a group of individuals, a class of individuals, an entity, a group of entities, a class of entities, a unit within the entity, a group of units within the entity or a class of units within the entity. Note that other user identifiers can be used. The recipient identifier can correspond to a vendor, a merchant, a financial institution, a governmental entity, another individual, another group of individuals, another class of individuals, another entity, another group of entities, another class of entities, another unit within the entity, another group of units within the entity or another class of units within the entity. Note that other recipient identifiers can be used.

The spectral decomposition of the set of transaction data can include projecting the set of transaction data into a frequency domain using a Fourier transformation, and identifying any dominant frequencies within the frequency domain. The Fourier transformation can be computed using the following mathematical formula:

$$F ( ω ) = {\sum }_{i = 1}^{n} {a}_{i} {e}^{- j ω ( {t}_{i} - {t}_{1} + 1 )}$$

where n is a total number of the data pairs in the transaction set, a is a transaction amount, and t is a transaction date. The one or more processors can classify the identified time-based pattern(s) into the at least two pattern categories by: classifying any data pairs that correspond to the identified dominant frequencies, if any, as the recurring transaction; and classifying any data pairs that do not correspond to the identified dominant frequencies as the non-recurring transaction.

Referring now to FIG. 2, a flow chart of a computerized method 200 in accordance with an embodiment of the present invention is shown. The computerized method 200 for detecting and responding to transaction patterns includes providing one or more processors communicably coupled to a communications interface and one or more databases in block 202. One or more time-based patterns are identified in a set of transaction data stored in the one or more databases corresponding to a data pair over a time period using a spectral decomposition of the set of transaction data by the one or more processors in block 204. The identified time-based pattern(s) are classified into at least two pattern categories comprising a recurring transaction and a non-recurring transaction using the one or more processors in block 206. One or more actions are generated for each pattern category using the one or more processors in block 208. The identified time-based pattern(s) are responded to by causing one or more remote devices communicably coupled to the one or more processors to perform the one or more actions via the communications interface in block 210. As will be appreciated by those of ordinary skill the art, the steps described herein can be omitted or combined and that additional steps (not shown) can be added. In some circumstances, the steps can be performed simultaneously or in another order and/or repeated.

The remote device(s) can include a server, computer, laptop computer, hand-held computing device, mobile communications device, electronic token, electronic wearable device (e.g., wrist watch, bracelet, glasses, etc.), transaction processing device (e.g., point-of-sale device, kiosk, cash register, credit/debit card machine, etc.) or a payment processing system. Note that other devices can be used. The transaction can be a purchase, a sale, a lease, an order, a payment, a deposit, a transfer, a receipt or a barter exchange. Note that other types of transactions can be used. Moreover, the transaction can be a pending or proposed transaction awaiting approval or authorization. The one or more actions can include displaying a recommended course of action on the one or more remote devices, displaying an alert or warning on the one or more remote devices, displaying a prompt to cancel or allow a pending transaction, the recurring transaction or the non-recurring transaction on the one or more remote devices, or blocking the pending transaction, the recurring transaction or the non-recurring transaction until an override message is received from the one or more remote devices. Note that other types of actions can be used. Moreover, the one or more actions can execute other application(s) or software program(s) resident on the remote device(s) or cause the remote device(s) to communicate or interact with other devices with or without user interaction.

The method 200 can further include one or more of the following steps:

selecting the data pair from at least one user identifier and at least one recipient identifier stored in a data structure in the one or more databases; or

selecting the data pair from the at least one user identifier and at least one transaction category stored in the data structure in the one or more databases; or

receiving the transaction data comprising at least a user identifier, a recipient identifier, a date and an amount, and storing the transaction data in a data structure in the one or more databases; or

requesting the transaction data from one or more third party devices; or

assigning a transaction category to the transaction data; or

creating a data array of transactions corresponding to the data pair over the time period, wherein the set of transaction data comprises the data array of transactions, and storing the data array of transactions in a first array data structure in the one or more databases; or

storing the spectral decomposition of the set of transaction data in a second array data structure in the one or more databases; or

generating the one or more actions by selecting the one or more actions from a mapping of each pattern category to a set of actions in a pattern to action table stored in the one or more databases; or

storing the one or more actions in a user action table in the one or more databases; or

responding to the identified time-based pattern(s) by further querying the one or more actions in the user action table; or

receiving a new transaction data corresponding to a new completed transaction, a new pending transaction or a new predicted transaction, and storing the new transaction data in the data structure; or

adding the new transaction data to the set of transaction data, and repeating the analyzing, classifying, generating and responding steps; or

generating one or more new actions whenever the new transaction data matches one or more of the pattern categories, or invoking one or more of the stored actions, and causing the one or more remote devices communicably coupled to the one or more processors to perform the one or more new actions via the communications interface; or

determining whether the recommended course of action was performed, sending a congratulatory message to the one or more remote devices whenever the recommended course of action was performed, and sending an alert message to the one or more remote devices whenever the recommended course of action was not performed; or

receiving a cancellation message, which may include an authorization code, from the one or more remote devices in response to the prompt, and sending a cancellation request to a third-party device for the pending transaction, the recurring transaction or the non-recurring transaction; or

receiving an allow message from the one or more remote devices in response to the prompt, and sending an authorization message to a third-party device for the pending transaction; or

executing one or more applications on the one or more remote devices in response to the one or more actions; or

determining a geographic location of a user, and predicting a destination location based on the geographic location of the user and one of the recurring transactions or one of the non-recurring transactions associated with the user, wherein the one or more actions are based on the destination location.

The user identifier can correspond to an individual, a group of individuals, a class of individuals, an entity, a group of entities, a class of entities, a unit within the entity, a group of units within the entity or a class of units within the entity. Note that other user identifiers can be used. The recipient identifier can correspond to a vendor, a merchant, a financial institution, a governmental entity, another individual, another group of individuals, another class of individuals, another entity, another group of entities, another class of entities, another unit within the entity, another group of units within the entity or another class of units within the entity. Note that other recipient identifiers can be used.

The spectral decomposition of the set of transaction data can include projecting the set of transaction data into a frequency domain using a Fourier transformation, and identifying any dominant frequencies within the frequency domain. The Fourier transformation can be computed using the following mathematical formula:

$$F ( ω ) = {\sum }_{i = 1}^{n} {a}_{i} {e}^{- j ω ( {t}_{i} - {t}_{1} + 1 )}$$

where n is a total number of the data pairs in the transaction set, a is a transaction amount, and t is a transaction date. The one or more processors can classify the identified time-based pattern(s) into the at least two pattern categories by: classifying any data pairs that correspond to the identified dominant frequencies, if any, as the recurring transaction; and classifying any data pairs that do not correspond to the identified dominant frequencies as the non-recurring transaction.

In addition, the present invention can be implemented as a non-transitory computer readable medium containing program instructions that cause one or more processors to perform a method for detecting and responding to transaction patterns as described above in reference to the computerized method.

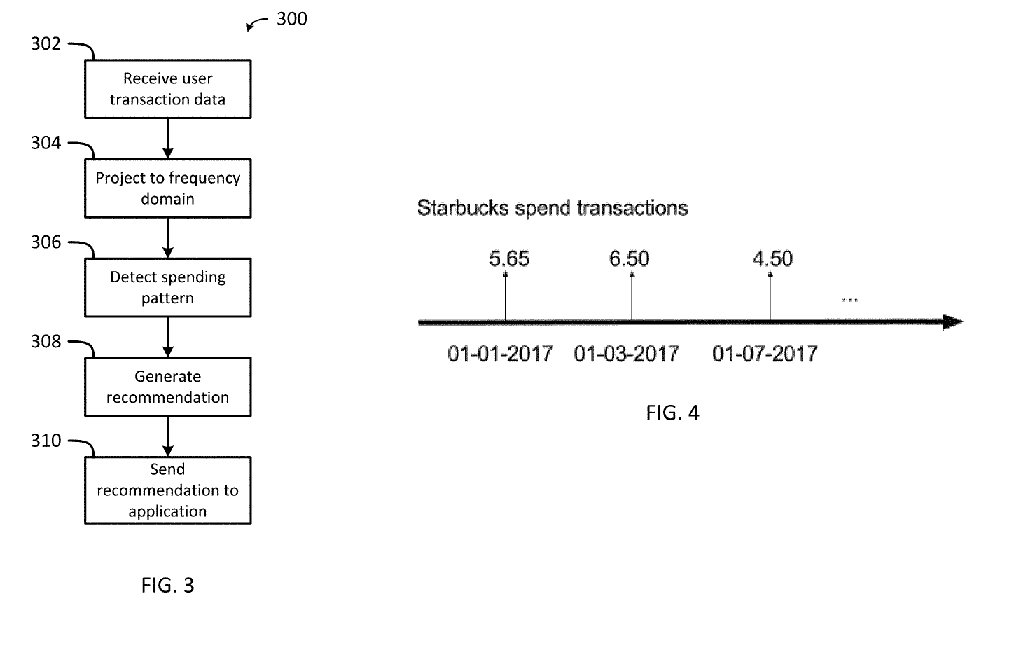

Now referring to FIGS. 3-10, an non-limiting example of the present invention will be described in which patterns in spending behavior of a financial entity or person are discovered with the goal of providing financial recommendations based on their spending patterns. FIG. 3 shows a flow chart of a method 300 in which a user's transaction data is received and stored as a data structure to be analyzed for identifying patterns in block 302. A spectral decomposition of transaction data is calculated, using Fourier transformation, to identify dominant frequencies (representing patterns) in the data in block 304. Then the patterns are classified into categories of recurring spendings and sporadic non-recurring spendings in block 306. A recommendation is assigned to each category of spendings and it is stored in a user insight table in block 308. This is done using a mapping from different types of patterns to suggested actions. The insights from the user insights table are used to send recommendation(s) to the application to be illustrated to the user in block 310.

Various examples of spectral decomposition of spending patterns will now be described. As shown in the table below, customer transaction data can be represented as a structured database where each row represents a transaction with merchant information, amount of transaction as well as the date that the transaction was posted.

TABLE 1
Data array representation for transactions
between a merchant and a user over time.

| Day | User | Merchant | Date | Amount |
|---|---|---|---|---|
| 1 | 1 | Starbucks | Jan. 1, 2017 | $5.65 |
| 1 | 1 | Uber | Jan. 1, 2017 | $15.00 |
| 3 | 1 | Starbucks | Jan. 3, 2017 | $6.50 |
| 5 | 1 | Amazon | Jan. 5, 2017 | $65.00 |
| 7 | 1 | Starbucks | Jan. 7, 2017 | $4.50 |
| . . . | . . . | . . . | . . . | . . . |

As shown in FIG. 4, the transaction data for each customer is processed into a form of array of transactions between each merchant (e.g., Starbucks and the user), where each variable represents the value of the transaction for the merchant: $5.65 on Jan. 1, 2017; $6.50 on Jan. 3, 2017; and $4.50 on Jan. 7, 2017. This array is projected into Fourier domain by computing the following mathematical transformation on the transaction array:

$$F ( ω ) = {\sum }_{i = 1}^{n} {a}_{i} {e}^{- j ω ( {t}_{i} - {t}_{1} + 1 )}$$

where n is a total number of the data pairs in the transaction set, a is a transaction amount, and t is a transaction date.

For the example shown in Table 1 and FIG. 4, the mathematical transformation is:

$$F ( ω ) = 5.65 {e}^{- j ω1} + 6.50 {e}^{- j ω 3} + 4.50 {e}^{- j ω 7} + …$$

The decomposition provides different intensities for different frequencies (ω) of spending as shown in FIG. 5 for the Starbucks example: 60 days; 30 days; 10 days; 5 days; and 1 day. Note that other transformation techniques can be used.

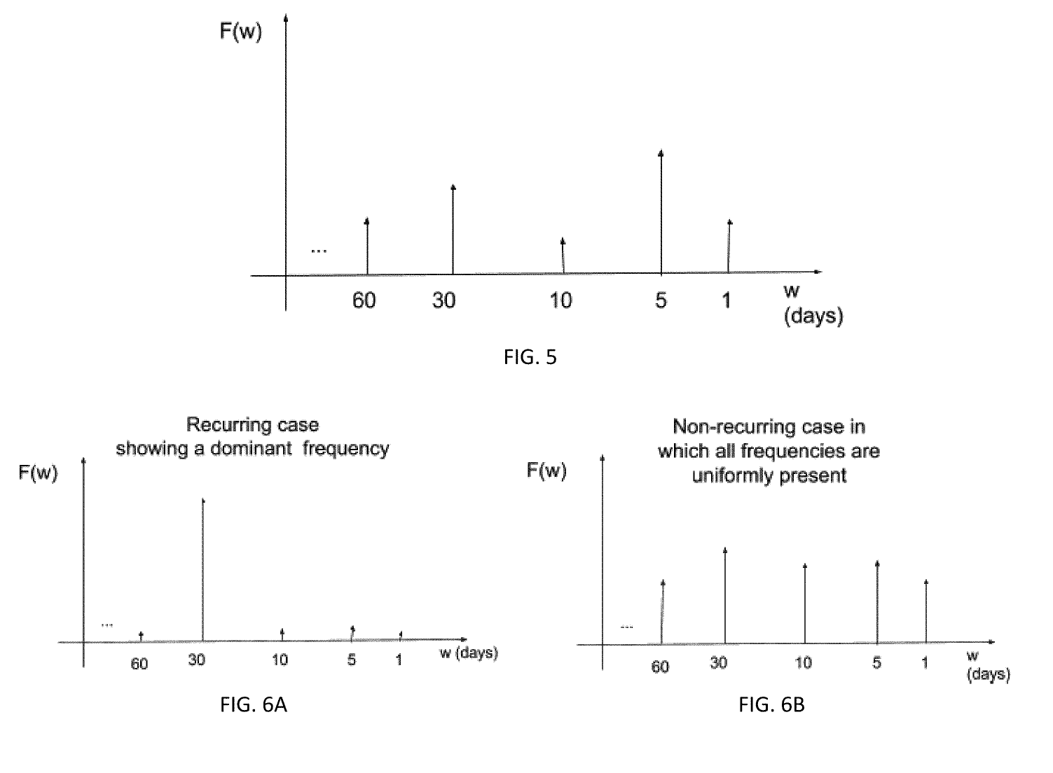

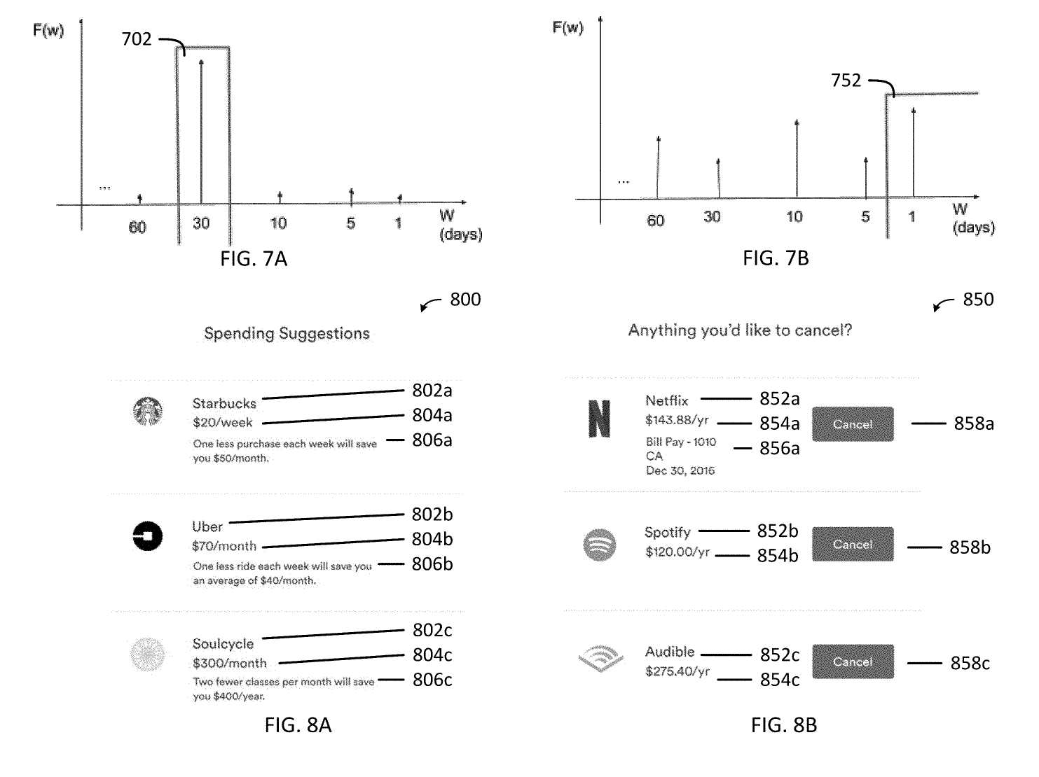

Thereafter, actions and recommendations are determined based on patterns as illustrated in FIGS. 6A-6B and 7A-7B. In this example, the spectral outcome is then classified into two categories, where the first includes cases identified as recurring with a certain frequency based on the spectrum and second involves cases where the spectrum is flat and doesn't show and dominant frequency (recurrence).

The first case shown in FIG. 6A shows that the customer has a tendency to transact with a specific frequency (e.g., weekly or monthly), while the second case shown in FIG. 6B models a case where the customer doesn't have a specific frequency and shows sporadic spending in different frequencies. For example, FIG. 6A shows a dominant frequency at 30 days were the value is considerably higher than the values at 60 days, 10 days 5 days and 1 day. In contrast, FIG. 6B shows the values at the various frequencies, 60 days, 30 days, 10 days 5 days and 1 day, are relatively similar to one another. The process then branches into two different responses. First, if there is a dominant frequency (e.g., 30 days), the process would flag that frequency 702 and provide a suggestion for the customer to reduce the recurrence of the specific spending as illustrated in FIG. 7A. Second, the process would give recommendations based on a high frequency filter, such as every day 752 as illustrated in FIG. 7B.

The process can also provide recommendations or suggestions to reduce spending on non-recurring transactions or cancelling bills that are recurring with an identified frequency. For the case of non-recurring transactions in which the user spends sporadically, the process provides recommendations on how to reduce that spending. FIGS. 8A-8B shows examples of suggestions and recommendations for specific transactions: suggestions to reduce specific sporadic but non-recurring transactions (FIG. 8A), requesting cancellation of specific recurring charges (FIG. 8B). As shown in FIG. 8A, exemplary spending suggestions 800 could display the merchant or vendor name, the approximate amount spent per time period and a suggestion to reduce the spending with an expected savings over a time period:

Starbucks 802a

$20/week 804a

“One less purchase each week will save you $50/month” 806a

Uber 802b

$70/month 804b

“One less ride each week will save you on average $40/month” 806b

Soulcycle 802c

$300/month 804c

“Two fewer classes per month will save you $400/year” 806c

As shown in FIG. 8B, exemplary recommendations for cancelling of recurring charges 850 could display the merchant or vendor name, the approximate amount spent per time period, the payment mechanism used and a “button” to select/click to cancel the recurring charge:

Netflix 852a

$143.88/year 854a

“Bill Pay—1010 CA Dec 30, 2016” 856

“Cancel” 858a

Spotify 852b

$120.00/year 854b

“Cancel” 858b

Audible 852c

$275.40/year 854c

“Cancel” 858c.

Other information, data and actions can be displayed.

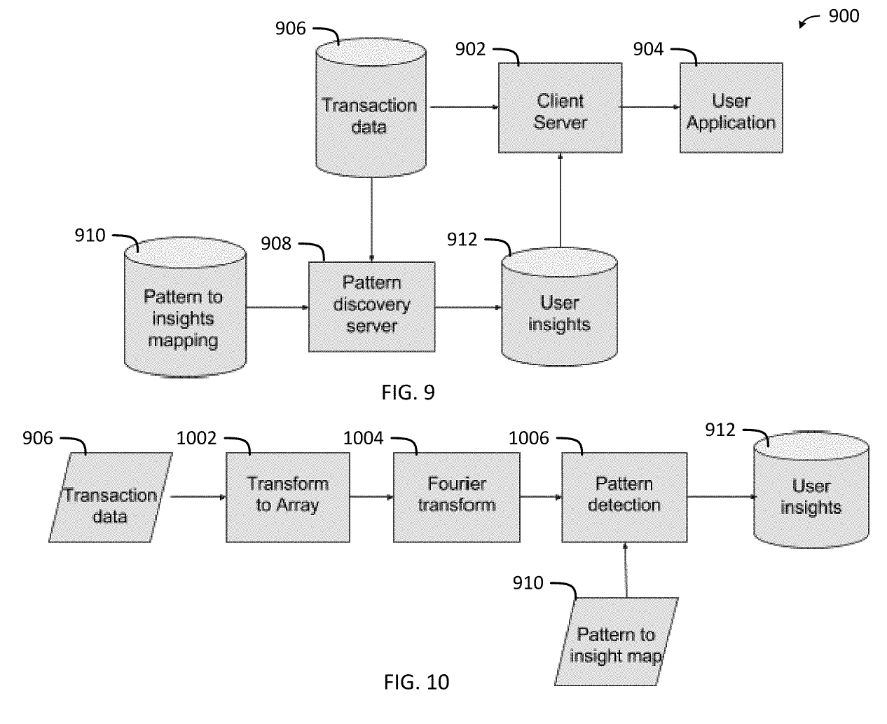

In this non-limiting example, the system is built on a separate server using customer transaction data as illustrated in the flow chart of FIG. 9. The system and method 900 are integrated with the client server 902 providing suggestions and important parameters to the application 904.

Transaction data 906 is processed into arrays of time points as illustrated in FIG. 4 which is stored in an array data structure in memory for optimizing processing time. The frequency domain transformation, shown in FIG. 5, is stored as an array data structure in the memory and analyzed further for patterns using the pattern discovery server 908. The pattern discovery server 908 matches the identified patterns to recommendations using the pattern to insights mapping table 910, which are stored in a user insights table 912 in a format such as is shown in the table below.

TABLE 2
Data structure for pattern to insight mapping.

| Pattern | Merchant | Recommendation |
|---|---|---|
| Sporadic Pattern | Starbucks | You have been to Starbucks yesterday, |
| | | consider not going today. |
| Recurring Pattern | Netflix | Cancel subscription. |
| . . . | . . . | . . . |

The user insights table 912 is queried by the client server 902 and the result is sent to the user application 904.

Now referring to FIG. 10, a non-limiting example of a flow chart of a pattern determination method 1000 is shown. The transaction data 906 is transformed into an array data structure in block 1002. Thereafter, the array is projected into the Fourier domain in block 1004 and pattern detection is performed in block 1006. The identified patterns are matched to recommendations using the pattern to insights mapping table 910, and the recommendations are stored in the user insights table 912.

The system and method may also provide other features, such as geolocation to predict where the transaction will be taking place for non-recurring spendings and provide real time alerts and saving advice. In this case the process will be actively intervening as opposed to just providing recommendations. Moreover, the process can be integrated with the payment processing systems to send alerts when the user violates the recommended insights, which could be done by prompting the user to override a block of the transaction.

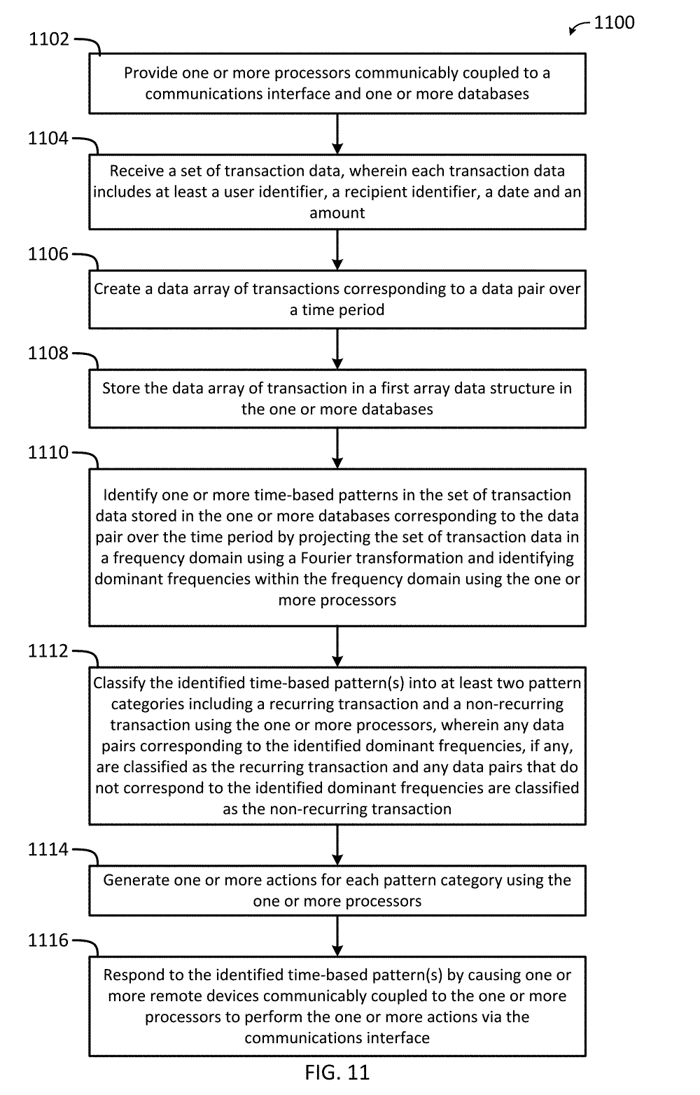

Referring now to FIG. 11, a flow chart of a method 1100 in accordance with an embodiment of the present invention is shown. The computerized method 1100 for detecting and responding to transaction patterns includes providing one or more processors communicably coupled to a communications interface and one or more databases in block 1102. A set of transaction data is received, wherein each transaction data includes at least a user identifier, a recipient identifier, a date and an amount in block 1104. A data array of transactions corresponding to a data pair over a time period is created from the set of transaction data in block 1106. The data array of transactions is stored in a first array data structure in the one or more databases in block 1108. One or more time-based patterns are identified in the set of transaction data stored in the one or more databases corresponding to the data pair over the time period by projecting the set of transaction data into a frequency domain using a Fourier transformation and identifying any dominant frequencies within the frequency domain using the one or more processors in block 1110. The identified time-based pattern(s) are classified into at least two pattern categories including a recurring transaction and a non-recurring transaction using the one or more processors, wherein any data pairs corresponding to the identified dominant frequencies, if any, are classified as the recurring transaction and any data pairs that do not correspond to the identified dominant frequencies are classified as the non-recurring transaction in block 1112. One or more actions are generated for each pattern category using the one or more processors in block 1114. The identified time-based pattern(s) are responded to by causing one or more remote devices communicably coupled to the one or more processors to perform the one or more actions via the communications interface in block 1116. Note that the computerized method 1100 can include can further include one or more of the additional step described above in reference to FIG. 2. As will be appreciated by those of ordinary skill the art, the steps described herein can be omitted or combined and that additional steps (not shown) can be added. In some circumstances, the steps can be performed simultaneously or in another order and/or repeated.

The present invention can be implemented as a system 100 as described in reference to FIG. 1 that performs the computerized method described above in reference to FIG. 11.

In addition, the present invention can be implemented as a non-transitory computer readable medium containing program instructions that cause one or more processors to perform the computerized method described above in reference to FIG. 11.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of.” As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step, or a limitation) or group of integers (e.g., feature(s), element(s), characteristic(s), property(ies), method/process(s) steps, or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about,” “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the devices and/or methods disclosed and claimed herein can be made and executed without undue experimentation in light of the present disclosure. While the devices and/or methods of this invention have been described in terms of particular embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope, and concept of the invention as defined by the appended claims.

Furthermore, no limitations are intended to the details of construction or design herein shown, other than as described in the claims below. It is therefore evident that the particular embodiments disclosed above may be altered or modified and all such variations are considered within the scope and spirit of the disclosure. Accordingly, the protection sought herein is as set forth in the claims below.

Modifications, additions, or omissions may be made to the systems and apparatuses described herein without departing from the scope of the invention. The components of the systems and apparatuses may be integrated or separated. Moreover, the operations of the systems and apparatuses may be performed by more, fewer, or other components. The methods may include more, fewer, or other steps. Additionally, steps may be performed in any suitable order.

To aid the Patent Office, and any readers of any patent issued on this application in interpreting the claims appended hereto, applicants wish to note that they do not intend any of the appended claims to invoke paragraph 6 of 35 U.S.C. § 112 as it exists on the date of filing hereof unless the words “means for” or “step for” are explicitly used in the particular claim.

What is claimed is:

1. A computerized method for detecting and responding to transaction patterns comprising:
providing one or more processors communicably coupled to a communications interface and one or more databases;
identifying one or more time-based patterns in a set of transaction data stored in the one or more databases corresponding to a data pair over a time period using a spectral decomposition of the set of transaction data by the one or more processors;
classifying the identified time-based pattern(s) into at least two pattern categories comprising a recurring transaction and a non-recurring transaction using the one or more processors;
generating one or more actions for each pattern category using the one or more processors; and
responding to the identified time-based pattern(s) by causing one or more remote devices communicably coupled to the one or more processors to perform the one or more actions via the communications interface.

2. The method of claim 1, further comprising:
selecting the data pair from at least one user identifier and at least one recipient identifier stored in a data structure in the one or more databases using the one or more processors; or
selecting the data pair from the at least one user identifier and at least one transaction category stored in the data structure in the one or more databases using the one or more processors.

3. The method of claim 1, further comprising:
receiving the transaction data comprising at least a user identifier, a recipient identifier, a date and an amount; and
storing the transaction data in a data structure in the one or more databases.

4. The method of claim 3, further comprising requesting the transaction data from one or more third party devices.

5. The method of claim 3, further comprising assigning a transaction category to the transaction data.

6. The method of claim 3, wherein:
the user identifier corresponds to an individual, a group of individuals, a class of individuals, an entity, a group of entities, a class of entities, a unit within the entity, a group of units within the entity or a class of units within the entity;
the recipient identifier corresponds to a vendor, a merchant, a financial institution, a governmental entity, another individual, another group of individuals, another class of individuals, another entity, another group of entities, another class of entities, another unit within the entity, another group of units within the entity or another class of units within the entity;
the transaction comprises a purchase, a sale, a lease, an order, a payment, a deposit, a transfer, a receipt or a barter exchange; or
the one or more remote devices comprise a server, a computer, a laptop computer, a hand-held computing device, a mobile communications device, a transaction processing device or a payment processing system.

7. The method of claim 1, further comprising:
creating a data array of transactions corresponding to the data pair over the time period, wherein the set of transaction data comprises the data array of transactions; and
storing the data array of transactions in a first array data structure in the one or more databases.

8. The method of claim 1, further comprising storing the spectral decomposition of the set of transaction data in a second array data structure in the one or more databases.

9. The method of claim 1, wherein the spectral decomposition of the set of transaction data comprises:
projecting the set of transaction data into a frequency domain using a Fourier transformation; and
identifying any dominant frequencies within the frequency domain.

10. The method of claim 9, wherein the Fourier transformation comprises F(ω)=Σᵢ₌₁ⁿaᵢe^{-jω(t}^{ᵢ}^{-t}^{₁}⁺¹⁾ where n is a total number of the data pairs in the transaction set, a is a transaction amount, and t is a transaction date.

11. The method of claim 9, wherein classifying the identified time-based pattern(s) into the at least two pattern categories comprises:
classifying any data pairs that correspond to the identified dominant frequencies, if any, as the recurring transaction; and
classifying any data pairs that do not correspond to the identified dominant frequencies as the non-recurring transaction.

12. The method of claim 1, wherein generating the one or more actions comprises selecting the one or more actions from a mapping of each pattern category to a set of actions in a pattern to action table stored in the one or more databases.

13. The method of claim 1, further comprising storing the one or more actions in a user action table in the one or more databases.

14. The method of claim 13, wherein responding to the identified time-based pattern(s) further comprises querying the one or more actions in the user action table.

15. The method of claim 1, further comprising:
receiving a new transaction data corresponding to a new completed transaction, a new pending transaction or a new predicted transaction; and
storing the new transaction data in the data structure.

16. The method of claim 15, further comprising:
adding the new transaction data to the set of transaction data; and
repeating the analyzing, classifying, generating and responding steps.

17. The method of claim 15, further comprising:
generating one or more new actions whenever the new transaction data matches one or more of the pattern categories, or invokes one or more of the stored actions; and
causing the one or more remote devices communicably coupled to the one or more processors to perform the one or more new actions via the communications interface.

18. The method of claim 1, wherein the one or more actions comprise:
displaying a recommended course of action on the one or more remote devices;
displaying an alert or warning on the one or more remote devices;
displaying a prompt to cancel or allow a pending transaction, the recurring transaction or the non-recurring transaction on the one or more remote devices; or
blocking the pending transaction, the recurring transaction or the non-recurring transaction until an override message is received from the one or more remote devices.

19. The method of claim 18, further comprising:
determining whether the recommended course of action was performed;
sending a congratulatory message to the one or more remote devices whenever the recommended course of action was performed; and
sending an alert message to the one or more remote devices whenever the recommended course of action was not performed.

20. The method of claim 18, further comprising:
receiving a cancellation message from the one or more remote devices in response to the prompt; and
sending a cancellation request to a third-party device for the pending transaction, the recurring transaction or the non-recurring transaction.

21. The method of claim 20, further comprising including an authorization code in the cancellation message.

22. The method of claim 18, further comprising:
receiving an allow message from the one or more remote devices in response to the prompt; and
sending an authorization message to a third-party device for the pending transaction.

23. The method of claim 1, further comprising executing one or more applications on the one or more remote devices in response to the one or more actions.

24. The method of claim 1, further comprising:
determining a geographic location of a user;
predicting a destination location based on the geographic location of the user and one of the recurring transactions or one of the non-recurring transactions associated with the user; and
wherein the one or more actions are based on the destination location.

25. A system for detecting and responding to transaction patterns comprising:
one or more servers having one or more processors;
one or more databases communicably coupled to the one or more servers;
one or more remote devices communicably coupled to the one or more servers; and
the one or more processors:
identify one or more time-based patterns in a set of transaction data stored in the one or more databases corresponding to a data pair over a time period using a spectral decomposition of the set of transaction data,
classify the identified time-based pattern(s) into at least two pattern categories comprising a recurring transaction and a non-recurring transaction,
generate one or more actions for each pattern category, and
respond to the identified time-based pattern(s) by causing the one or more remote devices to perform the one or more actions.

26. The system of claim 25, wherein the one or more processors further:
select the data pair from at least one user identifier and at least one recipient identifier stored in a data structure in the one or more databases; or
select the data pair from the at least one user identifier and at least one transaction category stored in the data structure in the one or more databases.

27. The system of claim 25, wherein the one or more processors further:
receive the transaction data comprising at least a user identifier, a recipient identifier, a date and an amount; and
store the transaction data in a data structure in the one or more databases.

28. The system of claim 27, wherein the one or more processors further request the transaction data from one or more third party devices.

29. The system of claim 27, wherein the one or more processors further assign a transaction category to the transaction data.

30. The system of claim 27, wherein:
the user identifier corresponds to an individual, a group of individuals, a class of individuals, an entity, a group of entities, a class of entities, a unit within the entity, a group of units within the entity or a class of units within the entity;
the recipient identifier corresponds to a vendor, a merchant, a financial institution, a governmental entity, another individual, another group of individuals, another class of individuals, another entity, another group of entities, another class of entities, another unit within the entity, another group of units within the entity or another class of units within the entity;
the transaction comprises a purchase, a sale, a lease, an order, a payment, a deposit, a transfer, a receipt or a barter exchange; or
the one or more remote devices comprise a server, a computer, a laptop computer, a hand-held computing device, a mobile communications device, a transaction processing device or a payment processing system.

31. The system of claim 25, wherein the one or more processors further:
create a data array of transactions corresponding to the data pair over the time period, wherein the set of transaction data comprises the data array of transactions; and
store the data array of transactions in a first array data structure in the one or more databases.

32. The system of claim 25, wherein the one or more processors further store the spectral decomposition of the set of transaction data in a second array data structure in the one or more databases.

33. The system of claim 25, wherein the spectral decomposition of the set of transaction data comprises:
projecting the set of transaction data into a frequency domain using a Fourier transformation; and
identifying any dominant frequencies within the frequency domain.

34. The system of claim 33, wherein the Fourier transformation comprises F(ω)=Σᵢ₌₁ⁿaᵢe^{-jω(t}^{ᵢ}^{-t}^{₁}⁺¹⁾ where n is a total number of the data pairs in the transaction set, a is a transaction amount, and t is a transaction date.

35. The system of claim 33, wherein one or more processors classify the identified time-based pattern(s) into the at least two pattern categories by:
classifying any data pairs that correspond to the identified dominant frequencies, if any, as the recurring transaction; and
classifying any data pairs that do not correspond to the identified dominant frequencies as the non-recurring transaction.

36. The system of claim 25, wherein the one or more processors generate the one or more actions by selecting the one or more actions from a mapping of each pattern category to a set of actions in a pattern to action table stored in the one or more databases.

37. The system of claim 25, wherein the one or more processors further store the one or more actions in a user action table in the one or more databases.

38. The system of claim 37, wherein the one or more processors respond to the identified time-based pattern(s) by further querying the one or more actions in the user action table.

39. The system of claim 25, wherein the one or more processors further:
receive a new transaction data corresponding to a new completed transaction, a new pending transaction or a new predicted transaction; and
store the new transaction data in the data structure.

40. The system of claim 39, wherein the one or more processors further:
add the new transaction data to the set of transaction data; and
repeat the analyzing, classifying, generating and responding steps.

41. The system of claim 39, wherein the one or more processors further:
generate one or more new actions whenever the new transaction data matches one or more of the pattern categories, or invokes one or more of the stored actions; and
cause the one or more remote devices communicably coupled to the one or more processors to perform the one or more new actions via the communications interface.

42. The system of claim 25, wherein the one or more actions comprise:
displaying a recommended course of action on the one or more remote devices;
displaying an alert or warning on the one or more remote devices;
displaying a prompt to cancel or allow a pending transaction, the recurring transaction or the non-recurring transaction on the one or more remote devices; or
blocking the pending transaction, the recurring transaction or the non-recurring transaction until an override message is received from the one or more remote devices.

43. The system of claim 42, wherein the one or more processors further:
determine whether the recommended course of action was performed;
send a congratulatory message to the one or more remote devices whenever the recommended course of action was performed; and
send an alert message to the one or more remote devices whenever the recommended course of action was not performed.

44. The system of claim 42, wherein the one or more processors further:
receive a cancellation message from the one or more remote devices in response to the prompt; and
send a cancellation request to a third-party device for the pending transaction, the recurring transaction or the non-recurring transaction.

45. The system of claim 44, wherein the one or more processors further include an authorization code in the cancellation message.

46. The system of claim 42, wherein the one or more processors further:
receive an allow message from the one or more remote devices in response to the prompt; and
send an authorization message to a third-party device for the pending transaction.

47. The system of claim 25, wherein the one or more processors further execute one or more applications on the one or more remote devices in response to the one or more actions.

48. The system of claim 25, wherein the one or more processors further:
determine a geographic location of a user;
predict a destination location based on the geographic location of the user and one of the recurring transactions or one of the non-recurring transactions associated with the user; and
wherein the one or more actions are based on the destination location.

49. A non-transitory computer readable medium containing program instructions that cause one or more processors to perform a method for detecting and responding to transaction patterns comprising:
providing one or more processors communicably coupled to a communications interface and one or more databases;
identifying one or more time-based patterns in a set of transaction data stored in the one or more databases corresponding to a data pair over a time period using a spectral decomposition of the set of transaction data by the one or more processors;
classifying the identified time-based pattern(s) into at least two pattern categories comprising a recurring transaction and a non-recurring transaction using the one or more processors;
generating one or more actions for each pattern category using the one or more processors; and
responding to the identified time-based pattern(s) by causing one or more remote devices communicably coupled to the one or more processors to perform the one or more actions via the communications interface.

50. A computerized method for detecting and responding to transaction patterns comprising:
providing one or more processors communicably coupled to a communications interface and one or more databases;
receiving a set of transaction data, each transaction data comprising at least a user identifier, a recipient identifier, a date and an amount;
creating a data array of transactions corresponding to a data pair over a time period from the set of transaction data;
storing the data array of transactions in a first array data structure in the one or more databases;
identifying one or more time-based patterns in the set of transaction data stored in the one or more databases corresponding to the data pair over the time period by projecting the set of transaction data into a frequency domain using a Fourier transformation and identifying any dominant frequencies within the frequency domain using the one or more processors;
classifying the identified time-based pattern(s) into at least two pattern categories comprising a recurring transaction and a non-recurring transaction using the one or more processors, wherein any data pairs corresponding to the identified dominant frequencies, if any, are classified as the recurring transaction and any data pairs that do not correspond to the identified dominant frequencies are classified as the non-recurring transaction;
generating one or more actions for each pattern category using the one or more processors; and
responding to the identified time-based pattern(s) by causing one or more remote devices communicably coupled to the one or more processors to perform the one or more actions via the communications interface.

51. A system for detecting and responding to transaction patterns comprising:
one or more servers having one or more processors;
one or more databases communicably coupled to the one or more servers;
one or more remote devices communicably coupled to the one or more servers; and
the one or more processors:
receive a set of transaction data, each transaction data comprising at least a user identifier, a recipient identifier, a date and an amount,
create a data array of transactions corresponding to a data pair over a time period from the set of transaction data,
store the data array of transactions in a first array data structure in the one or more databases,
identify one or more time-based patterns in the set of transaction data stored in the one or more databases corresponding to the data pair over the time period by projecting the set of transaction data into a frequency domain using a Fourier transformation and identifying any dominant frequencies within the frequency domain using the one or more processors,
classify the identified time-based pattern(s) into at least two pattern categories comprising a recurring transaction and a non-recurring transaction using the one or more processors, wherein any data pairs corresponding to the identified dominant frequencies, if any, are classified as the recurring transaction and any data pairs that do not correspond to the identified dominant frequencies are classified as the non-recurring transaction,
generate one or more actions for each pattern category, and
respond to the identified time-based pattern(s) by causing the one or more remote devices to perform the one or more actions.
